(19) United States
(12) Patent Application Publication
(10) Pub. No.: US 2006/0143974 A1
(43) Pub. Date: Jul. 6, 2006

(54) Device for repelling insects moving along the ground

(76) Inventor: Walter Pollmann, Herborn-Horbach (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/526,727

(22) PCT Filed: Aug. 21, 2003
(86) PCT No.: PCT/EP03/09290

§ 371 Date: Sep. 26, 2005

(30) Foreign Application Priority Data
Sep. 3, 2002 (DE) 10241122.0

(51) Int. Cl. A01M 1/22

(52) U.S. Cl. 43/112

(57) ABSTRACT

The invention relates to a device (01, 20, 22) for repelling insects (03, 08) that move along the ground, particularly termites, so as to protect buildings or parts of buildings. The inventive device comprises a support element (12, 21, 23) that is made of an electrically insulating material and at least two electrical conductor elements (04, 05, 06) which are disposed thereupon parallel to and at a distance from each other and between which a voltage can be applied by means of a voltage source. The distance between the conductor elements (04, 05, 06) is at least slightly smaller than the length of the insects (03, 08) that are to be repelled such that the insects (03, 08) form a current-conducting connection between the conductor elements (04, 05, 06) when passing the support element (12, 21, 23) perpendicular to the conductor elements (04, 05, 06). Said conductor elements (04, 05, 06) run in a vertically staggered manner at different heights. An at least small difference in height exists between the lowest conductor element (06) and the subjacent surface (07).

The invention relates to a device for driving away insects moving along the ground, in particular, termites, according to the preamble of claim 1.

In specific regions, in particular, the United States, South Africa, and Canada, specific types of insects, in particular, termites, represent a threat to buildings with regard to building components which must be taken seriously. In particular, buildings made of wood or wood components are threatened by these insects, since, for example, termites also can destroy construction components within a few days.

To prevent this risk, typically large amounts of insecticides are utilized at the construction site, in order to kill the termites living in the surrounding environment. This method, however, brings substantial ecological disadvantages and in addition, is expensive due to the high price of the insecticides. A further disadvantage is that termites, after some time, can migrate again into the surrounding environment of the house, so that new insecticide must be sprayed. The types of devices with conductive elements having a voltage, for example, are known for driving away pigeons. These known devices, however, are tailored specifically to the type of animal to be driven away, and therefore, is not suited for driving away insects moving along the ground.

The object of the present invention, therefore, is to propose a new device for driving away insects that move along the ground.

This object is solved with a device according to the teachings of claim 1.

Advantageous embodiments of the invention are the subject matter of the dependent claims.

According to the present invention, with the new device, a spacing between conductive elements is selected, which is at least minimally smaller than the length of the insects to be driven away. In this manner, the insects create a conductive connection between the conductive elements upon crossing the support element in the direction transverse to the conductive elements, and by means of the released current flow along their bodies, are driven away. Of great importance for the functioning of the device for expelling insects moving across the ground is that the conductive elements are not covered by insects that already were stunned or killed by an electric shock. If the conductive elements were covered, namely by killed or stunned insects, then for subsequent insects, the possibility would exist of overcoming the barrier formed by the conductive elements via these killed or stunned animals. According to the present invention, therefore, the conductive elements of the device are arranged vertically at different heights over one another, whereby between the lowermost conductive element and the underlying surface, at least a minimal height difference is provided. By this structure, animals that were already killed or stunned by electric shock fall below based on the gravitational forces after receiving the shock. The height difference between the lowermost conductive element and the underlying surface therefore must be selected to be so large that with the dropping of multiple animals, covering of the conductive elements first is impossible. Of course, with the use of the device of the present invention over a long period of time, it is not impossible that by dropping down, a plurality of insects could form a mountain beneath the conductive elements. For this case, the region beneath the conductive elements, then, must be cleaned, for example, by sweeping.

In other words, the present invention for driving away insects moving along the ground according to the present invention relates to the basic concept that the insects expelled by the effect of the voltage between the conductive elements are kept far from the conductive elements based on gravity, so that the conductive elements are not blocked by stunned or killed insects.

According to a preferred embodiment of the invention, the support element is formed as a smooth surface on the side of the conductive elements. In this manner, the footing of insects climbing upwardly along the support element additionally is made more difficult, so that these insects, after receiving the electric shock, fall down reliably.

How large the acting gravitational force is on the stunned or killed insects depends ultimately on the incline of the connecting surface on the support element, which joins both conductive elements to one another. The force due to gravity acting on the insects, therefore, is greater the more steeply the connecting surface is arranged. Therefore, it is particularly advantageous if the connecting surface between the conductive elements extends perpendicular upwardly or is arranged even to be overhanging. By this perpendicular or overhanging arrangement of the connecting surface, the insects, upon falling down, no longer find any footing, but starting from the conductive elements, fall into the free, underlying space.

Devices of the present invention must be arranged regularly in outside areas, whereby the problem of unwanted short circuits between the conductive elements by moisture in the air, in particular, rain, exists. This problem is made worse with devices according to the present invention, in that the conductive elements are arranged over one another, so that particles of moisture, in particular rain drops, upon beading up along the surface of the support element, can easily cause short circuits. To avoid this problem caused by moisture, according to another preferred embodiment of the present invention, a protective element can be provided above the conductive elements. By means of this protective element, the conductive elements are protected from above and/or also on the sides, so that, in particular, rain drops cannot enter through the sides of the support element with the conductive elements. In this connection, however, it should be noted that between the protective element and the conductive elements, a sufficiently larger intermediate space is formed, so that the insects can climb upward in this intermediate space on the support element and thereby, contact the conductive elements.

In order to protect the conductive elements also from moisture entering from the sides, for example, rain drops falling at an angle, the protective element should extend at least for a bit downwardly.

The structure and construction of the device of the present invention that is used is basically user-defined and can be determined based on the respective application. According to a first embodiment, the support element is formed in the manner of an elastically deformable film along the longitudinal axis running parallel to the conductive elements. This embodiment makes possible adapting the support element flexibly to the contour of other objects, so that, for example, round base posts can be protected by a simple placement of the elastic support film.

According to a second embodiment, the support element is formed in the manner of a stably formed strip, whose lower end can be pressed into the ground. As a result, by using this embodiment, a barrier can be erected with any additional means on the surface of the ground, which can not be overcome by the insect pests.

According to a third embodiment, the support element is formed in the manner of a profile strip, which is attached to a natural barrier device, for example, a square timber for protection from the insects.

So that the insects cannot erode the natural barrier device, according to a preferred embodiment of the invention, a film on the barrier device is provided, which extends downwardly into the ground.

As for the suitable spacing between the conductive elements for most insects, the spacing is between 5 and 50 mm. In particular, a spacing of 10 to 20 mm is suitable for driving away most types of termites.

As a supply voltage, between the conductive elements, 200 to 5000 Volts, preferably, 400 to 1000 Volts, can be applied, whereby the control apparatus for applying this supply voltage must be formed, such that upon formation of a short circuit between the conductive elements by contact of one of the insects, only a relatively small amount of current flows. The goal specifically should be not to kill the insects, but merely to stun them to a point that they fall below on the device. This has the advantage that the insects, based on their communication with their fellow termites, see to it that the other insects no longer undertake any further attempts at crossing. For most types of insects, a current power of 0.1 to 0.6 Joule with formation of a short circuit is sufficient to stun, but not kill, the insects.

According to a preferred embodiment, four conductive elements are provided on the device, which extend parallel to one another along the longitudinal axis of the device. In this manner, as a result, a double barrier is formed, through which the crossing of the insects is reliably barred. Conductive elements that are adjacent to one another, therefore, should preferably be connected with opposite polarity to the voltage source.

In addition, it is advantageous if the conductive elements are formed to be wavy or forked along their longitudinal axes. By this structure, the natural orientation of the insects is disturbed.

Multiple embodiments of the present invention are shown schematically in the drawings and are explained next by way of example.

In the drawings:

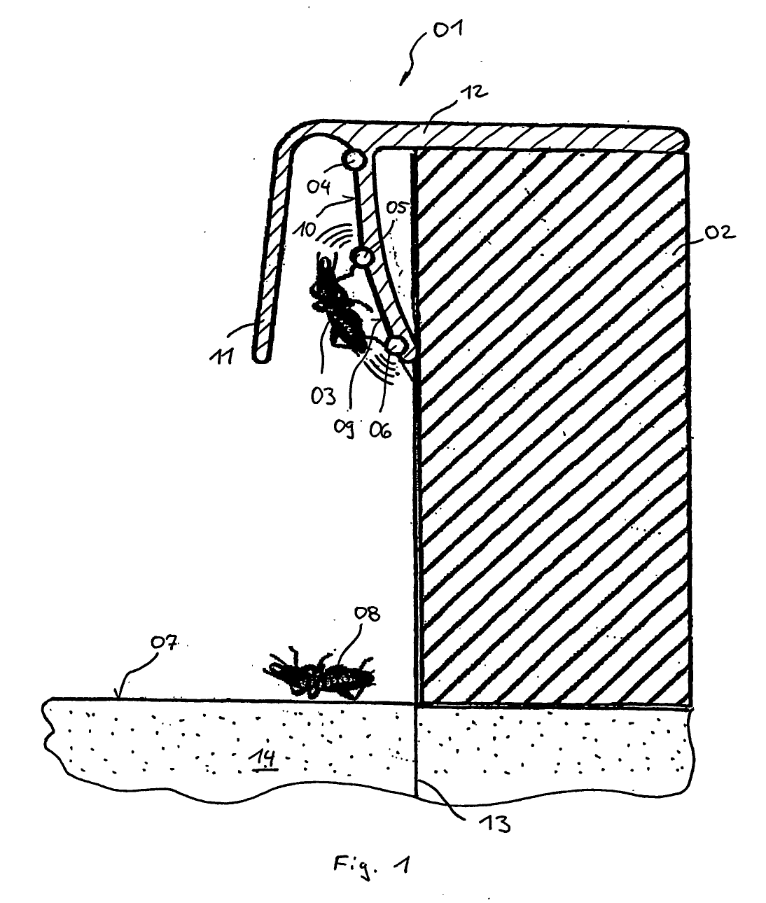

FIG. 1 shows a first embodiment of a device according to the present invention in cross section;

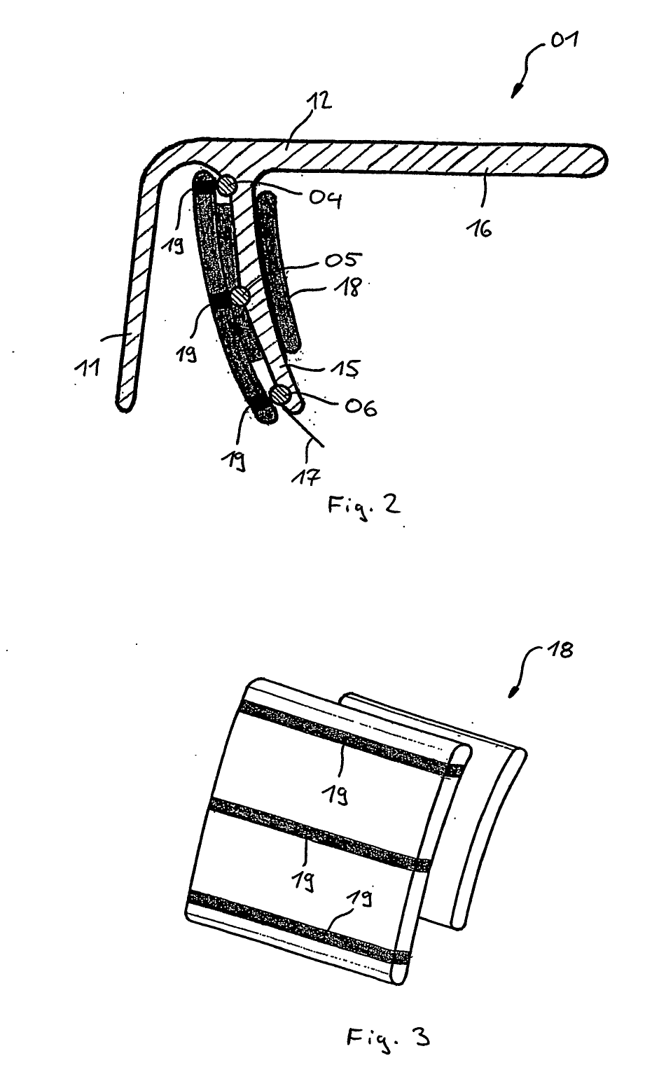

FIG. 2 shows the device according to FIG. 1 with a suitable coupling device in cross section;

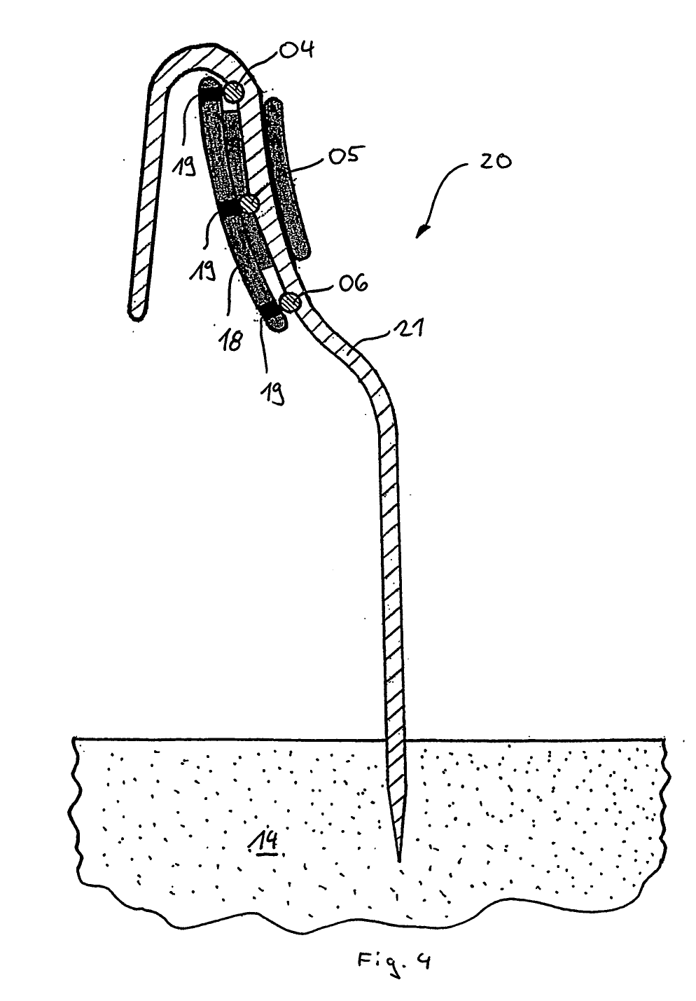

FIG. 3 shows the coupling device according to FIG. 2 in perspective view;

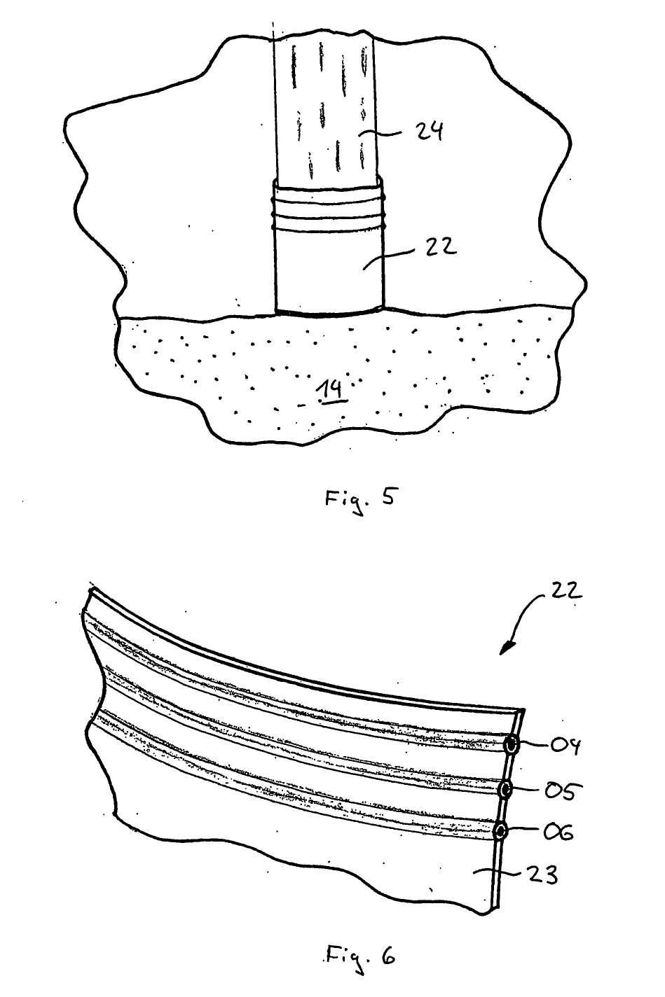

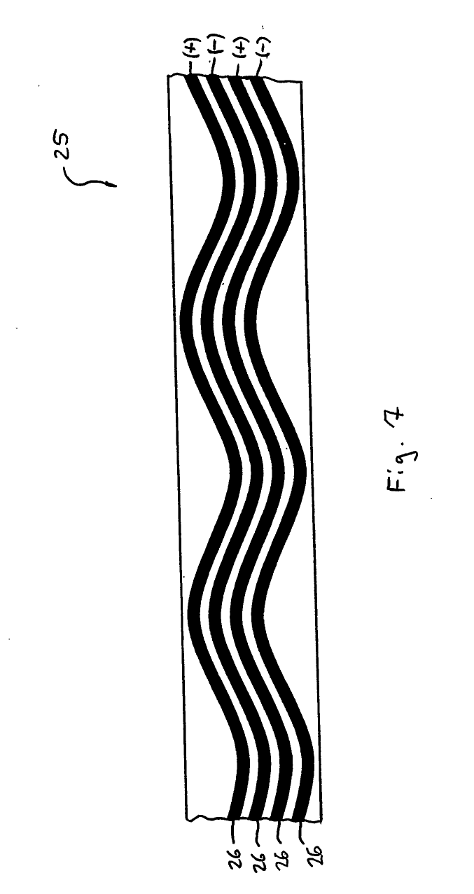

FIG. 4 shows a second embodiment of the device of the present invention in cross section;

FIG. 5 shows a third embodiment of the device of the present invention in a side view;

FIG. 6 shows the device according to FIG. 5 in an enlarged perspective representation;

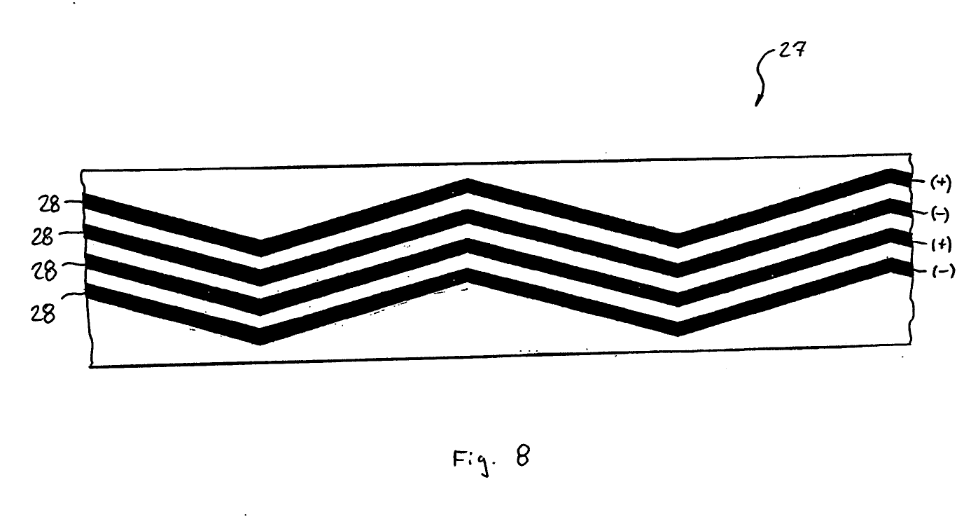

FIG. 7 shows a fourth embodiment of the device of the present invention in a view from the front; and

FIG. 8 shows a fifth embodiment of the device of the present invention in a view from the front.

The device 01 shown in FIG. 1 is formed in the manner of a profile strip, namely, an angular profile and can be attached to a square timber serving as a barrier device 02. The device 01 preferably is provided for defense against termites 03. For achieving this purpose, on the device 01, conductive elements 04, 05, 06 in the form of copper conductive wires are provided, which are connected to a voltage source (not shown). By connection of the voltage to the conductive elements 04, 05, 06 with different polarity, an electrical voltage is formed between the conductive elements 04 and 05 on the one hand and the conductive elements 05 and 06 on the other hand. The spacing between the conductive elements 04, 05, 06 is selected to be so large, that it is reliably ensured that upon crossing of termites 03 transverse to the conductive elements 04, 05, 06, a current-conducting connection is formed by the body of the termite 03. As soon as this conductive connection is formed by the termite 03, a short surge flows through the body of the termite 03, which stuns or kills the termite 03, so that the termite 03 falls in a free fall downwardly until reaching the underlying surface 07. This situation is represented by a second termite 08. So that the dropping of the termites 03 or 08 is reliably ensured, the connecting surfaces 09 and 10 between the conductive elements 04, 05, 06 are formed to have a smooth surface. In addition, the connecting surfaces 09 and 10 overhang with an angle of 100 to 200, in order to enable a free fall space beneath the lowermost conductive element 06.

In order to protect the conductive elements 04 to 06 from unwanted short circuits by moisture falling onto the connecting surfaces 09 and 10, an overhanging protective element 11 is provided on the device 01, which preferably is formed as one piece on the support element, which is made from plastic and formed as an angular profile.

In order to make the erosion of the barrier device 02 more difficult or entirely impossible, a plastic film 13 is attached on the front side of the barrier device 02, whose lower part is buried in the ground 14. The depth of the lower edge of the plastic film 13 must be determined based on the respective capability for digging underground pathways of the type of insect to be driven away.

In FIG. 2, the device 01 is shown in an enlarged representation with the conductive elements 04, 05, and 06, the support element 12 forming an angular profile, and the protective element 11 hanging over forward. The support element 12 has two legs 15 and 16, whereby the leg 16 serves to attach the device 01 to the barrier device 02 and the leg 15 to support the conductive elements 04, 05 and 06. Both legs 15 and 16 form an angle less than 900 with one another and based on their one-piece manufacture from an elastic plastic, are elastically connected to one another. In this manner, it is possible that the leg 15, upon mounting of the leg 16 on the barrier device 02, is pressed with its lower edge against the side surface of the barrier device 02. Then, based on the acute angle between the legs 15 and 16, by pressing on of the device 01 against the corner edge of the barrier device 02, the transition region between the legs 15, 16 can be elastically deformed, and thereby, the lower edge of the leg 15 pressed on. By this feature, a larger gap cannot be formed between the lower edge of the leg 15 and the surface of the barrier device 02, also with a surface that is not absolutely smooth, so that the termites cannot crawl into the intermediate space between the back side of the leg 15 and the barrier device 02. This sealing of the intermediate space is improved even more if a sealing element 17, formed as a sealing lip, is provided additionally on the lower edge of the leg 15. This sealing lip 17 rests elastically on the surface of the barrier element 02 and compensates for unevenness within a large tolerance range.

In addition, in FIG. 2, a coupling device 18 is shown, which can be used for connecting multiple devices 01. In this connection, the coupling device 18 is attached to the ends of the devices 01, whereby, by means of bridge elements 19 provided on the coupling device, upon attachment of the coupling device, an electrical contact between conductive elements 04, 05, or 06 is created. On the ends of the device 01, respectively, a short notch is provided, with which the coupling device 18 can engage about the leg 15 on the front and back sides.

In FIG. 4, a second embodiment 20 of the device of the present invention is shown in cross section. The structure of the device 20 corresponds with regard to the conductive elements 04, 05, 06 or with regard to the protective element 11 to the structure of the device 01. But the leg 16 for attachment to a barrier device 02 is omitted, since the device 20 is formed in the manner of a stably formed strip, whose support element 21 can be pressed into the ground 14 with the pointed lower end. For connecting multiple devices 20, again, coupling devices 18 with bridge elements 19 can be used.

In FIG. 5, a third embodiment 22 of a device according to the present invention is shown, which is suited, in particular, for protecting base posts. With the device 22, the support element 23 is made from a flexible plastic film, so that the device 22 can be placed on any shape. By means of the conductive elements 04, 05 and 06, which project on the upper end of the device 22 over the surface of the support element 23, again an acting barrier is formed by an electrical voltage, which cannot be overcome by termites climbing up the base post 24.

In FIG. 7, a fourth embodiment 25 of a device according to the present invention is shown in a view from the front. The conductive elements 26 are wavy and are alternatingly connected to the plus-pole and minus-pole of a voltage source.

In FIG. 8, fifth embodiment 27 of a device according to the present invention is shown in a view from the front. The conductive elements 28 are forked and are alternatingly connected to the plus-mole and minus-pole of a voltage source.

### REFERENCE NUMERAL LIST

01 device
02 barrier device
03 termite
04 conductive element
05 conductive element
06 conductive element
07 surface
08 termite
09 connecting surface
10 connecting surface
11 protective element
12 support element
13 plastic film
14 ground
15 lower leg
16 lateral leg
17 sealing element
18 coupling device
19 bridge element
20 device
21 support element
22 device
23 support element
24 base post
25 device
26 conductive element
27 device
28 conductive element

1. A device (01, 20, 22) for driving away insects (03, 08) moving along the ground, in particular, termites, in order to protect buildings or building parts, with a support element (12, 21, 23) made from an electrical insulating material and at least two electrical conductive elements (04, 05, 06) arranged spaced-apart thereon parallel to one another, between which an electrical voltage can be applied by means of a voltage source,
characterized in that,
the distance between the conductive elements (04, 05, 05) is at least minimally smaller than the length of the insects (03, 08) to be driven away, so that the insects (03, 08), upon passing the support element (12, 21, 23) in a direction transverse to the conductive elements (04, 05, 06) form a current-conducting connection between the conductive elements (04, 05, 06), wherein the conductive elements (04, 05, 06) run vertically offset in different heights, and wherein between the lower most conductive element (06) and the surface (07) lying thereunder, at least one minimal height difference is provided.

2. The device according to claim 1, characterized in that the support element (12, 21, 23) is formed as a smooth surface on the side of the conductive elements (04, 05, 06).

3. The device according to claim 1, characterized in that a connecting surface (09, 10) extends upwardly between the conductive elements (04, 05, 06) or hangs over the surface (07).

4. The device according to claim 1, characterized in that with the formation of an intermediate chamber above the conductive elements (04, 05, 06), a protective element (11) is arranged, which protects the conductive elements (04, 05, 06) from moisture.

5. The device according to claim 4, characterized in that the protective element (11) extends at least partially downwardly.

6. The device according to claim 1, characterized in that the support element (23) is formed in the manner of an elastically deformable film at least along its longitudinal axis running parallel to the conductive elements (04, 05, 06).

7. The device according to claim 1, characterized in that the support element (21) is formed in the manner of a stably formed profile strip, whose lower end can be pressed into the ground (14).

8. The device according to claim 1, characterized in that the support element (12) is formed in the manner of a profile strip, which is attachable to a barrier device (02) that is a natural barrier for the insects.

9. The device according to claim 8, characterized in that the barrier device (02) is formed in the manner of a square timber.

10. The device according to claim 8, characterized in that on the barrier device (02), a film (13) extending downwardly into the ground is attached.

11. The device according to claim 8, characterized in that the support element (12) is formed in the manner of an angular profile, wherein on the outer side of one of the legs (14), the conductive elements (04, 05, 06) are arranged, and wherein the inner sides of both legs (15, 16), upon attachment of the support element (12), come into contact at least partially on the barrier device.

12. The device according to claim 11, characterized in that at least one leg (16) of the angular profile has recesses, in order to attached the profile strip by mounting of attachment means, in particular, screws or nails, to the barrier device (02).

13. The device according to claim 11, characterized in that the inner sides of the two legs (15, 16) of the angular profile form an angle less than 90°, wherein both legs (15, 16) are connected at least partly elastically deformably with one another.

14. The device according to claim 11, characterized in that on the lower end of one of the legs (15), an elastic sealing element (17), in particular, a sealing lip made of rubber, is formed.

15. The device according to claim 1, characterized in that the end of the support element (12, 21) can be connected by means of a coupling device (18) with a further profile strip, whereby an electrical connection between associated conductive elements (04, 05, 06) is formed.

16. The device according to claim 15, characterized in that the coupling device (18) can be attached to the ends of the support element (12, 21).

17. The device according to claim 1, characterized in that the conductive elements (04, 05, 06) have a spacing of 5 to 50 mm, in particular, a spacing of 10 to 20 mm.

18. The device according to claim 1, characterized in that the conductive elements (04, 05, 06) are formed by conductive wires, in particular, made from copper or aluminum.

19. The device according to claim 1, characterized in that between the conductive elements (04, 05, 06), a supply voltage of 200V to 5000V is applied.

20. The device according to claim 1, characterized in that with formation of a current-conducting connection between the conductive elements (04, 05, 06), a current with a power of 0.1 to 0.6 Joules flows.

21. The device according to claim 1, characterized in that the support element (21) is made from thermoplastic plastic, in particular, PVC.

22. The device according to claim 1, characterized in that on the device (25, 27), four conductive elements (26, 28) are provided, which extend parallel to one another along the longitudinal axis of the device (25, 27).

23. The device according to claim 1, characterized in that conductive elements (26, 28) adjacent to one another are connected with different polarity to the voltage source.

24. The device according to claim 1, characterized in that the conductive elements (26) are formed to be wavy along their longitudinal axes.

25. The device according to claim 1, characterized in that the conductive elements (28) are formed to be forked along their longitudinal axes.

26. The device according to claim 1, characterized in that the forked section of the conductive elements (28) run at an angle of 5° to 22°, in particular, at an angle of approximately 16°.
